(19) United States
(12) Patent Application Publication
(10) Pub. No.: US 2024/0381499 A1
(43) Pub. Date: Nov. 14, 2024

(54) FOOD PROCESSING SYSTEMS AND MICROWAVE SUPPRESSION SYSTEMS

(71) Applicant: Alkar-RapidPak, Inc., Lodi, WI (US)

(72) Inventors: Craig R. Bonneville, Black Earth, WI (US); Paul Alton, Mason, NH (US); Ryan Gitzlaff, Pardeeville, WI (US); Ajitesh Yadav, Madison, WI (US); Graeme Bunce, Goffstown, NH (US); Mark Fitzgerald, Nashua, NH (US)

(73) Assignee: Alkar-RapidPak, Inc., Lodi, WI (US)

(21) Appl. No.: 18/658,505

(22) Filed: May 8, 2024

Related U.S. Application Data
(60) Provisional application No. 63/500,760, filed on May 8, 2023.

(51) Int. Cl. H05B 6/76; H05B 6/78

(52) U.S. Cl. CPC H05B 6/76; H05B 6/782

(57) ABSTRACT

A food processing system for processing a food product includes a module with a microwave generating device configured to generate microwave energy to process the food product, a conveyor extending through the module and configured to convey the food product through the module, and a microwave suppression system configured to prevent leakage of the microwave energy from the food processing system. The microwave suppression system includes a cover with a plurality of pin chokes coupled thereto that is movable relative to the conveyor and the module and selectively extends into the module.

### CROSS-REFERENCE TO RELATED APPLICATION

The present disclosure is based on and claims priority to U.S. Provisional Patent Application No. 63/500,760 filed May 8, 2023, the disclosure of which is incorporated herein by reference.

### FIELD

The present disclosure relates to food processing systems, and specifically to food processing systems with microwave suppression systems.

### BACKGROUND

The following U.S. patent and U.S. Patent Application Publication are incorporated herein by reference in entirety.

U.S. Pat. No. 11,412,584 discloses food processing machines for processing a food product having a housing, a conveyor for conveying the food product through the cavity, and a convection heating system for heating food products. A microwave launch box system is configured to emit microwave energy to further heat the food products.

U.S. Patent Application Publication No. 2022/0346198 discloses food processing machines for processing a food product with a microwave generating device configured to generate microwave energy. A waveguide assembly is configured to receive the microwave energy, direct the microwave energy along a waveguide axis, and subsequently direct the microwave energy to heat the food product.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In certain independent examples, a food processing system for processing a food product includes a module with a microwave generating device configured to generate microwave energy to process the food product, a conveyor extending through the module and configured to convey the food product through the module, and a microwave suppression system configured to prevent leakage of the microwave energy from the food processing system. The microwave suppression system includes a cover with a plurality of pin chokes coupled thereto that is movable relative to the conveyor and the module and selectively extends into the module.

Optionally the cover is movable into and between a first position in which the cover extends along the conveyor and a second position in which the cover extends transverse to the conveyor. Optionally in the first position at least a portion of the plurality of pin chokes extend into the module. Optionally in the first position the plurality of pin chokes are oriented toward the conveyor. Optionally in the second position the plurality of pin chokes are oriented away from the conveyor. Optionally the plurality of pin chokes extend perpendicular from a base plate of the cover. Optionally the food processing system further includes a pivot member that extends along a pivot axis and the cover is pivotable about the pivot axis in a first pivot direction away from the conveyor and an opposite second pivot direction toward the conveyor. Optionally the cover includes a bracket pivotably coupled to the pivot member. Optionally the food processing system further comprising a frame that vertically supports the conveyor, the microwave suppression system, and the module, and the pivot member is slidably coupled to the frame. Optionally the pivot member laterally extends across the conveyor. Optionally the cover is movable into an intermediate position between the first position and the second position. In the intermediate position the cover extends along the conveyor and is spaced apart from the module to the module and in the first position, the cover extends into the module. Optionally the cover is translatable between the first position and the intermediate position and the cover is pivotable between the intermediate position and the second position.

In certain independent examples, a method for processing a food product in a food processing system includes processing, with a module configured to generate microwaves, the food product, conveying, with a conveyor, the food product through the module, and moving a cover with pin chokes coupled thereto of a microwave suppression system relative to the module to selectively extend into the module and prevent leakage of microwaves from the food processing system.

Optionally the moving the cover includes moving the cover from a first position in which the cover extends along the conveyor to a second position in which the cover extends transverse to the conveyor. Optionally the moving the cover from the first position to the second position includes translating the cover along the conveyor and pivoting the cover about a pivot axis. Optionally the moving the microwave suppression system includes translating the cover along the conveyor from a first position in which the pin chokes extend into the module to an intermediate position in which the cover clears the module and pivoting the cover about a pivot axis away from the conveyor from the intermediate position toward a second position in which cover extends transverse to the conveyor. Optionally wherein the moving the microwave suppression system includes pivoting the cover about a pivot axis toward the conveyor from a second position in which the cover extends transverse to the conveyor to an intermediate position in which the cover and the pin chokes are adjacent to the module and translating the cover along the conveyor from the intermediate position to a first position in which the cover and the pin chokes extend into the module. Optionally in the first position, the plurality of pin chokes are oriented toward the conveyor. Optionally in the second position, the plurality of pin chokes are oriented away from the conveyor. Optionally in the second position, the plurality of pin chokes are oriented away from the conveyor.

Various other features, objects, and advantages will be made apparent from the following description taken together with the drawings.

### BRIEF DESCRIPTION OF THE DRAWINGS

The present disclosure is described with reference to the following Figures. The same numbers are used throughout the Figures to reference like features and like components.

FIG. 1 is a partial view of an example food processing system according to the present disclosure.

FIG. 2 is a cross-sectional view of an example microwave control module along line 2-2 on FIG. 1.

FIG. 3 is a perspective view of example waveguides of an example microwave control module. A first enclosure is excluded to expose internal components.

FIG. 4 is a perspective view of an example waveguide assembly.

FIG. 5 is a cross-sectional view of example waveguides and example extension assemblies.

FIG. 6 is a side view of an example cover of the present disclosure in a first position.

FIG. 7 is a side view of the example cover of FIG. 6 in an intermediate position.

FIG. 8 is a side view of the example cover of FIG. 6 in a second position.

FIG. 9 is an underside plan view of the example cover of FIG. 6.

FIG. 10 is a schematic diagram of an example control system of the present disclosure.

FIG. 11 is an example graphic representation of the microwave energy concentrations within a microwave control module according to the present disclosure.

### DETAILED DESCRIPTION

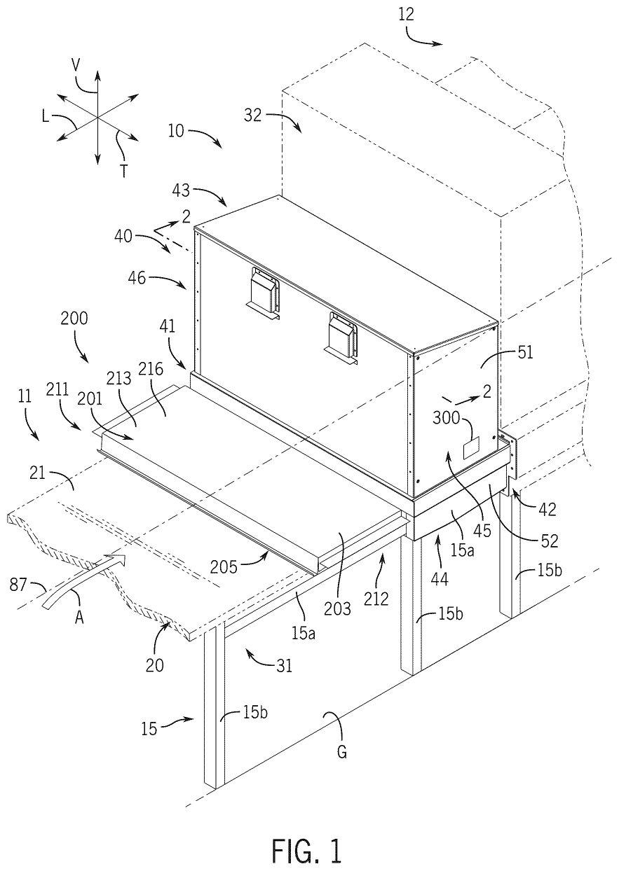

FIG. 1 partially depicts an example food processing machine or system 10, e.g., oven, according to the present disclosure. The system 10 has an upstream first end 11 configured to receive food products (not depicted; e.g., bacon, hamburgers, potato chips, snack foods) and an opposite downstream second end 12 that dispenses the cooked and/or heated food products. Note that the location of the second end 12 is schematically depicted by part number 12 in FIG. 1 as FIG. 1 depicts a partial view of the example system 10. An example food processing module 32 is partially depicted in dashed lines and coupled to an example microwave control module 40 (described hereinbelow).

Generally, the system 10 includes one or more modules positioned between the ends 11, 12 with a conveyor 20 extending between the ends 11, 12 along a longitudinal axis 87 (see also example longitudinal axis L). The conveyor 20 is configured to convey the food products (not depicted) from the first end 11 through the various modules and to the second end 12. The conveyor 20 conveys the food products in the downstream direction which is depicted by arrow A. In certain examples, the conveyor 20 is an endless belt conveyor with a belt 21 on which the food products are placed. The belt 21 can be formed with metallic materials. Note that in other examples the conveyor 20 includes other components such as chains, plates, hooks, troughs, non-metallic belts, and/or the like.

The system 10 can include several modules, systems, or sections, and in one example the system 10 includes (stated in order from the first end 11 to the second end 12) an infeed section 31, microwave suppression system 200, a microwave control module 40, a food processing module 32, and an outfeed module (not depicted). The infeed section 31 is configured to receive the food products from an upstream infeed equipment or machine (not depicted). In certain examples, the infeed section 31 includes components such as enclosure panels, knives, guide members for positioning the food product on the conveyor 20, and/or the like. The microwave control module 40 is configured to generate microwaves and apply the microwaves in a controlled and uniform distribution to the food products as the conveyor 20 as the food products are conveyed through the microwave control module 40. The food processing module 32 is configured to process (e.g., heat, cook, sear, cool) the food products as the food products are conveyed there through. The outfeed section (not depicted) dispenses the processed food product to the operator or another machine or system (not depicted; e.g., a packaging system configured to package the processed food products). Reference is made to above-incorporated U.S. Pat. No. 11,412,584 and U.S. Patent Application Publication No. 2022/0346198 which describe other food processing systems, sections, machines, ovens, modules, features, and/or components that can be utilized with the example food processing systems 10 described herein.

The example microwave control module 40 depicted in FIGS. 1-5 is located upstream from the food processing module 32. The microwave control module 40 generally extends along a longitudinal axis (see axis L in FIG. 1) between an upstream first module end 41 and an opposite downstream second module end 42, a vertical axis (see axis V in FIG. 1) between a top 43 and an opposite bottom 44, and a transverse axis (see axis T in FIG. 1) between a first side 45 and a second side 46. The microwave control module 40 includes a first enclosure 51 in which waveguide assemblies 90 are located and a second enclosure 52 vertically below the first enclosure 51 that at least partially surrounds the belt 21. The second module end 42 is coupled to and/or abuts the downstream food processing module 32 such the microwaves do not leak from between the modules 32, 40. In other examples, the microwave control module 40 is spaced apart from the food processing module 32. The microwave control module 40 is vertically supported by a frame 15 which is schematically depicted with longitudinally extending beams 15a and vertically extending posts 15b that contact the ground G.

In certain examples, the application of microwaves by the microwave control module 40 is different than the application of the microwaves in other known food processing module(s) (see for example above-incorporated U.S. Pat. No. 11,412,584 and U.S. Patent Application Publication No. 2022/0346198) because microwave energy is constrained within the interior space defined by the microwave control module 40 through which conveyor 20 conveys the food product which is electrically small with much higher field densities than conventional processing systems which emit microwave energy into a multimodal chamber such that a multimodal field pattern is produced. In the example microwave control modules 40 of the present disclosure, the microwave energy is applied directly to the food products within a small volume cavity. In certain examples, the microwave control module 40 is configured to prepare the food products for subsequent heating and/or cooking in a separate food processing module 32. In certain examples, the food processing systems 10 of the present disclosure advantageously utilize the food processing modules 32 with multimodal chambers in which microwave energy is utilized (see example modules in above-incorporated U.S. Patent Application Publication No. 2022/0346198) to perform a majority of the processing of the food products and further utilize the microwave control module 40 to pre-process the food products with microwave energy (e.g., the microwave control module 40 may generate microwave energy to defrost the food products, pulse the generated microwave energy to process the food products, and/or allow the temperature of the food products therein to equilibrate in the microwave control module) before the food products being conveyed to the food processing module 32 and/or post-process the food products with microwave energy (e.g., the microwave control module 40 may generate microwave energy to sear or brown the food products) after the food products being conveyed through the food processing module 32.

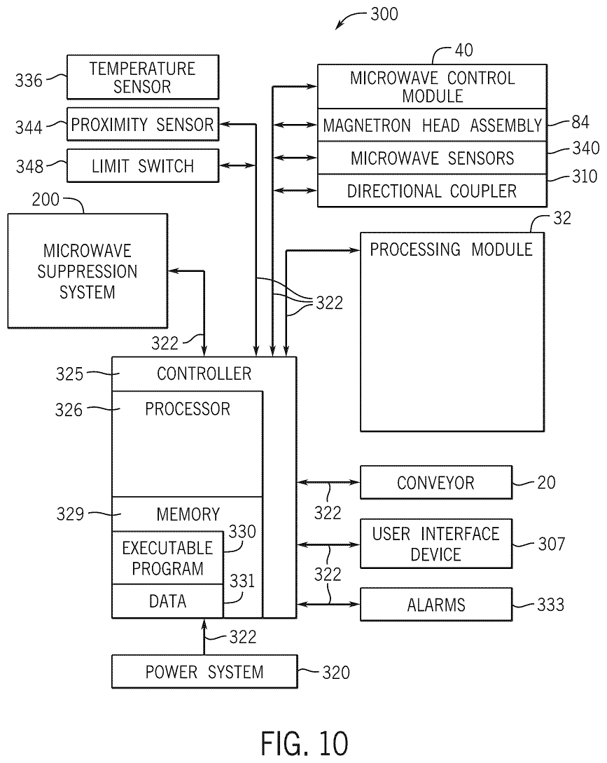

In certain examples, the microwave control module 40 utilizes the microwave energy in a different manner than the food processing module 32 by applying the microwave energy directly to the food product within a small space or zone that is a single wavelength or mode cavity zone as opposed to the food processing module 32 that has a multimodal chamber in which the microwaves are emitted. The microwaves in the food processing module 32 may reflect and propagate within the multimodal chamber. In certain examples, the processing module 32 emits microwave energy in the chamber such that the microwave energy in the chamber has a multi-mode field pattern. In certain examples, the microwave control module 40 has an interior space in which single wavelength microwave energy is emitted and the food products are processed by the microwave energy while being conveyed. In certain examples, the microwave control module 40 further advantageously applies microwaves to the food products such that the food products are in a condition for further processing downstream. For example, the microwave control module 40 may defrost the food products, increase the temperature of the food products to a predetermined preheat temperature, in order to adjust/fine tune final yield, product texture, and/or appearance. As will be described further herein, the amount of microwaves applied to the food products in the microwave control module 40 are directed by a control system 300 (FIG. 10) of the food processing system 10 and according to a recipe stored in the control system 300. In one example, the microwave control module 40 is configured to apply microwaves to frozen food products on the belt 21 to thereby defrost the food products before the food product. In this example, the defrosting of the food products advantageously places the food products in proper condition (e.g., defrosted) for heating and cooking in the food processing module 32. If in the event that the food products exit the microwave control module 40 in a defrosted condition, the microwave control module 40 may not apply any microwaves, apply small amounts of microwaves, pulsate the microwaves, and/or allow the temperature of the food products therein to equilibrate in the microwave control module.

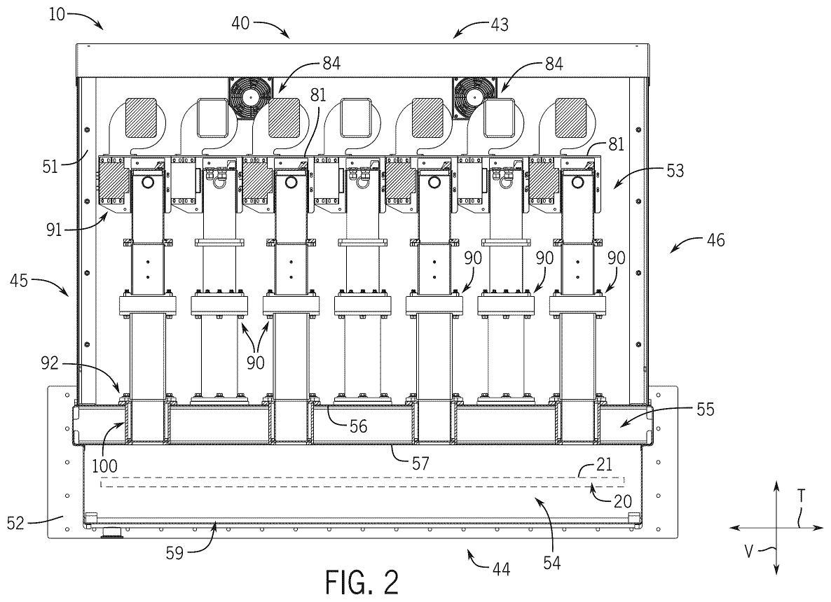

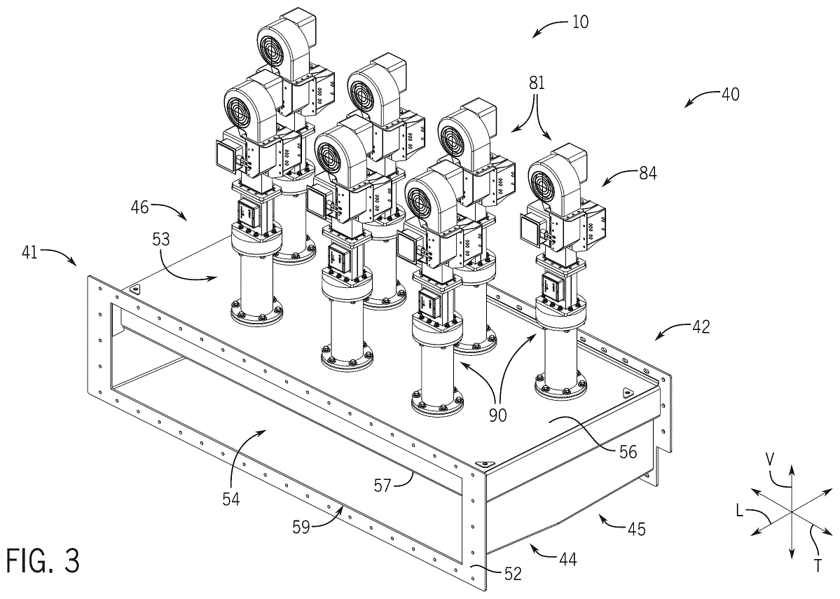

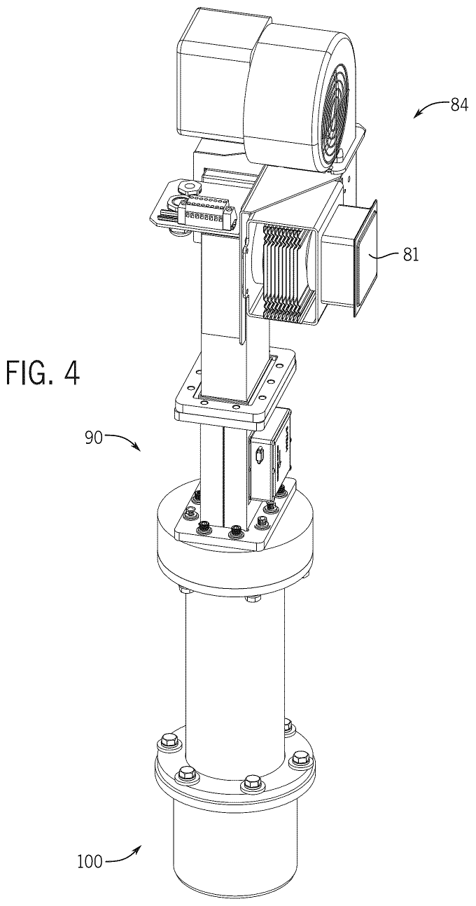

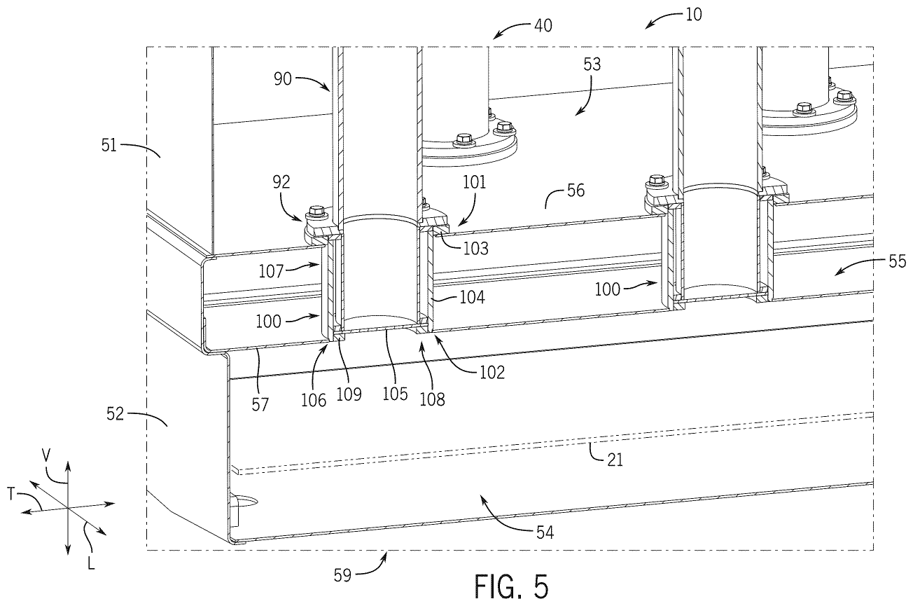

Turning now to FIGS. 2-5, the example microwave control module 40 is depicted in greater detail. FIG. 2 is a cross-sectional view of the microwave control module 40 along line 2-2 on FIG. 1, FIG. 3 is a perspective view of seven waveguide assemblies 90 coupled to a first mounting plate 56 of the microwave control module 40, FIG. 4 is a perspective view of an example waveguide assembly 90, and FIG. 5 is a cross-sectional view of example waveguide assemblies 90 (partially depicted) and example extension assemblies 100 of the present disclosure.

The first enclosure 51 defines a first interior space 53 in which a plurality of waveguide assemblies 90 are located. Each waveguide assembly 90 is configured to generate microwaves and/or direct the microwaves through the extension assembly 100 into the second enclosure 52. The microwaves heat or cook the food product(s) on the belt 21.

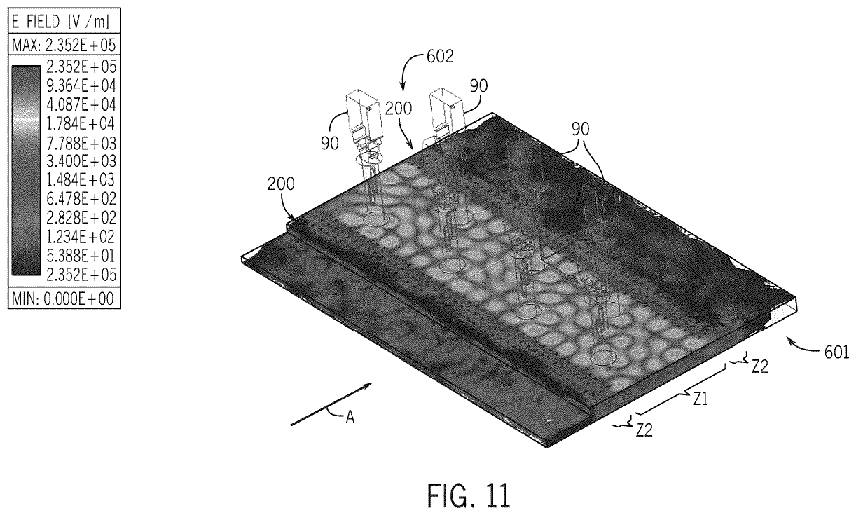

The number of waveguide assemblies 90 can vary, and in the example depicted, seven waveguide assemblies 90 are included. In certain examples, the number of waveguide assemblies 90 utilized depends on the amount of microwaves to be generated to process the food products, the size of the microwave control module 40, the desired microwave distribution for heating the food products, and/or the size of the magnetrons of the waveguide assemblies 90. Referring to FIG. 11, the microwave distribution pattern is graphically depicted for an example microwave control module 40 according to the present disclosure. A first side 601 of the image of FIG. 11 corresponds to a location near the first side 45 of the microwave control module 40 (see FIG. 1) and the second side 602 of the image of FIG. 11 corresponds to a location near the second side 46 of the microwave control module 40 (FIG. 1). The microwaves are concentrated and generally uniformly distributed within a first zone Z1 that corresponds to the second interior space 54 of the microwave control module 40 (See FIG. 2). A pair of microwave suppression systems 200 (examples of which are described hereinbelow) are located on both longitudinal sides of the second interior space 54 and are configured to suppress the microwaves such that the microwave energy is concentrated in the first zone Z1. FIG. 11 depicts a pair of second zones Z2 each on a side of the first zone Z1 and the microwave energy in the second zone Z2 is minimal and/or significantly reduced relative to the microwave energy in the first zone Z1 due to the positioning of the microwave suppression systems 200.

Referring back to FIGS. 2-5, a magnetron 81 can be coupled to and/or integral with each waveguide assembly 90, and the magnetron 81 can be one component of the magnetron head assembly 84. The magnetron head assembly 84 can include other components (e.g., transformer, capacitor, cooling fan/blower). The magnetron head assembly 84 includes a head waveguide through which the microwave energy passes out of the magnetron head assembly 84. An example of the magnetron head assembly 84 is a 2450.0 MHz open frame magnetron head assembly commercially available from MKS (part numbers TXO and TXA). Power supply units supply electrical power to the magnetron head assembly 84. Note that in other examples, the magnetrons are configured to emit microwave energy at other frequencies, such as 915.0 MHz.

The waveguide assembly 90 has a first end 91 coupled to and configured to receive the microwave energy from the magnetron head assembly 84. The waveguide assembly 90 also has an opposite second end 92 coupled to the first mounting plate 56 through which the microwave energy passes toward the belt 21. In certain examples, the waveguide assembly 90 is configured to transform microwave energy into polarized, spinning microwave energy and/or guide the microwave energy onto belt 21 and food products thereon. Reference is made to the example waveguide assemblies described in above-incorporated U.S. Patent Application Publication No. 2022/0346198 which features and components that may be utilized with the waveguide assemblies 90 of the present disclosure.

As noted above, the microwaves from the waveguide assemblies 90 are directed into the second interior space 54 through which the food products are conveyed by the conveyor 20, and the present inventors have recognized that moisture and debris can decrease the efficiency or effectiveness and/or cause damage to components of the waveguide assembly 90. As such, the present inventors have endeavored to prevent moisture and debris from entering the waveguide assemblies 90 via the second ends 92. Furthermore, the present inventors recognized that the system 10 can include components of the microwave control module 40 may need to be thoroughly cleaned in accordance with strict food safety regulations and/or procedures to ensure the quality and/or safety of the food products processed by the system 10. In addition, certain regulatory organizations and/or agencies may dictate and/or require frequent cleaning and sanitation of equipment in close proximity to the food products. Cleaning the waveguide assemblies 90 from moisture and debris can be costly and time-consuming leading to system 10 downtime. As such, the present inventors have endeavored to develop the example microwave control module 40 with unique assemblies, components, and connections therebetween to prevent moisture and debris from entering the waveguide assemblies 90 and/or allow for easy cleaning of components of the microwave control module 40.

The example microwave control module 40 depicted in FIGS. 2-5 includes one or more extension assemblies 100 that separate and/or maintain a space between the waveguide assembly 90 and the lower surface of a mounting plate 57 that faces the food products and the belt 21. The extension assembly 100 further allows the microwaves from the waveguide assembly 90 to propagate through the extension assembly 100 toward the food products on the belt 21. The microwave control module 40 includes a first mounting plate 56 and a second mounting plate 57 vertically spaced apart from the first mounting plate 56. A third interior space 55 is defined between the mounting plates 56, 57 (see FIG. 5), and the third interior space 55 is positioned between the first and second interior spaces 53, 54. In certain examples, the third interior space 55 advantageously insulates the first interior space 53 from the second interior space 54. In certain examples, the third interior space 55 is filled with insulative materials (e.g., foam) to prevent heat transfer between the first and second interior spaces 53, 54.

In certain examples, the third interior space 55 also advantageously and/or provides sufficient clearance between the mounting of the waveguide assemblies 90 on the first mounting plate 56 and a cap 105 (described in greater detail below) such that the cap 105 can removed for cleaning or replacement without disturbing the waveguide assemblies 90. For example, a waveguide assembly 90 can be demounted from the first mounting plate 56 without removing the corresponding caps 105. In this example, the caps 105 remain in place and maintain a debris and/or moisture barrier between the second interior space 54 and the first interior space 53.

The extension assembly 100 includes a first extension end 101, an opposite second extension end 102, and a body 107 having a sidewall 104 extending between the extension ends 101, 102. As such, the extension assembly 100 generally has a cylindrical shape and cross-sectional area along a vertical axis that extends through the extension assembly 100. In certain examples, the size and shape of the cross-sectional area correspond with waveguide assembly 90 such that the microwaves propagate through the extension assembly 100.

The first and second mounting plates 56, 57 have a plurality of aligned holes (not depicted) in which the extension assemblies 100 are received (e.g., the first mounting plate 56 has a first hole that is aligned with a first hole in the second mounting plate 57 and the extension assembly 100 is placed into the holes). The first extension end 101 includes a flange 103 that radially extends away from the sidewall 104, and the flange 103 rests on and/or abuts the top surface of the first mounting plate 56 when the extension assembly 100 is received in the holes of the mounting plates 56, 57. The second end 92 of the waveguide assembly 90 (depicted in FIG. 5 as semi-transparent for clarity) is positioned on the flange 103 and bolts (not depicted) secure the second end 92 of the waveguide assembly 90 and the flange 103 to the first mounting plate 56. The flange 103 is sandwiched and/or compressed between the second end 92 of the waveguide assembly 90 and the first mounting plate 56 such that a fluid-tight seal is formed between the flange 103 and the first mounting plate 56. The second extension end 102 of the extension assembly 100 engages the second mounting plate 57 to thereby form a fluid-tight seal therebetween. In certain examples, the second extension end 102 includes a lip 106 that engages with the top surface of the second mounting plate 57 and/or the edge or vertical surface that defines the hole in the second mounting plate 57. As such, a fluid-tight seal is formed between the second end 102 of the extension assembly 100 and the second mounting plate 57.

The cap 105 is located at the second extension end 102 and is configured to block or prevent moisture and/or debris from moving into the extension assembly 100 and further into the waveguide assembly 90. The cap 105 in the example depicted in FIG. 5 is a planar sheet of material that permits microwaves to pass there through (e.g., the gasket sheet material is microwave transparent). In one example, the cap 105 is formed of silicone rubber. In other examples, the cap 105 is formed of plastic such as polyetheretherketone (PEEK). The thickness of the cap 105 can vary, and in one example, the cap 105 is ⅛ inches thick. The shape of the cap 105 can also vary, and in one example, the cap 105 is a rectangularly shaped piece of planar material. In other examples, the cap 105 is a circular shaped piece of planar material. In the example depicted, the edges of the cap 105 are recessed into a groove 108 in the sidewall 104 and an annular plate 109 holds the cap 105 in place on the second extension end 102.

In one example maintenance or cleaning operation and/or replacement of the cap 105, the operator decouples the second end 92 of the waveguide assembly 90 from the flange 103 and the first mounting plate 56 by removing the bolts. The entire waveguide assembly 90 can then be removed or moved such that the extension assembly 100 is lifted out of the holes in the mounting plates 56, 57. The cap 105 is then removed, cleaned, and/or replaced. The extension assembly 100 can then be replaced into the holes in the mounting plates 56, 57 and the second end 92 of the waveguide assembly 90 recoupled to the flange 103 and the first mounting plate 56. As such, the microwave control module 40 is ready for operation. In another example, the extension assembly remains in the holes of the mounting plates 56, 67 while the waveguide assembly 90 and/or the cap 105 is removed.

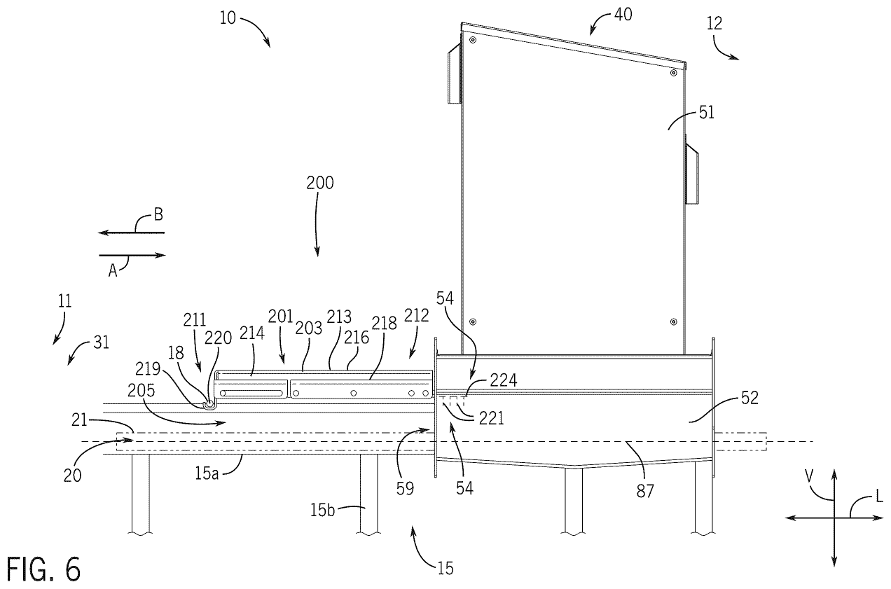

Referring to FIGS. 6-9, a microwave suppression system 200 is positioned adjacent to the upstream end of the microwave control module 40 and is for preventing microwaves from leaking out from the microwave control module 40. Note that the food processing module 32 (FIG. 1) is excluded from FIGS. 6-9 for clarity. The present inventors recognized that microwave energy emitting into the second interior space 54 from the extension assemblies 100 may pass out through the ends of the second interior space 54 through which the belt 21 extends. The present inventors recognized that microwave energy leaking from the system 10 can be harmful to workers working near the system 10 and that in some jurisdictions, governmental rules and standards dictate the maximum amount of microwave energy that can leak from equipment Accordingly, the present inventors developed the microwave suppression systems 200 (and components and assemblies thereof) of the present disclosure to reduce or eliminate the amount of leaking microwave energy that may otherwise leak or emit from the system 10. Note that while the microwave suppression systems 200 are described adjacent to the microwave control module 40, the microwave suppression systems 200 described herein can be utilized adjacent to the upstream or downstream ends of the food processing module 32 or any other component of the system 10 which microwaves are generated and/or utilized. For instance, the tunnel 201 is positioned next to the food processing module 32. In certain examples, the microwave suppression system 200 is part of the infeed section 31, the microwave control module 40, or the food processing module 32.

The microwave suppression system 200 includes a tunnel 201 that suppresses and/or absorbs microwave energy that passes through an opening 59 (FIG. 3) of the microwave control module 40. In other examples, the microwave suppression system 200 is provided downstream of the microwave control module 40 and/or the food processing module 32.

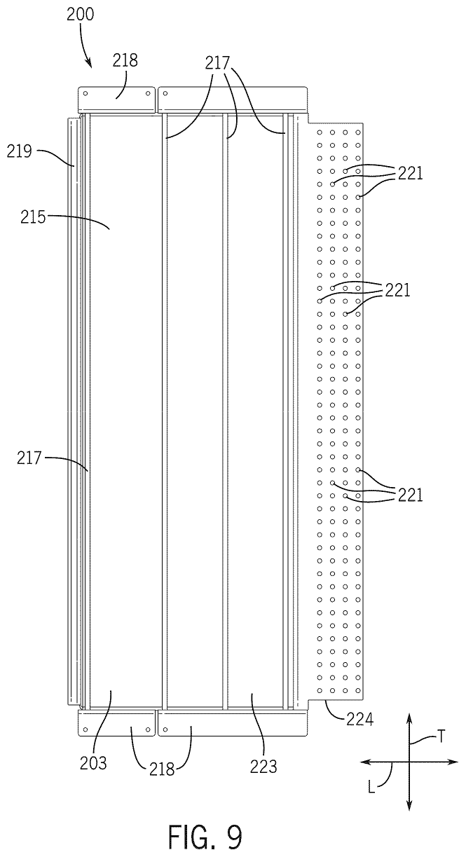

The tunnel 201 has a cover 203, an upstream first end 211, and a downstream second end 212 and defines a passageway 205 there between. The second end 212 is oriented toward the microwave control module 40. The cover 203 includes a base plate 213 and sidewalls 214 that vertically downwardly extend away from the perimeter edges of the base plate 213. The base plate 213 has a lower first surface 215 (FIG. 9) and an opposing upper second surface 216 (FIG. 1). The first surface 215 faces the conveyor 20 (see FIG. 6).

In certain examples, the tunnel 201 includes a lower plate (not depicted) that is vertically below the conveyor 20 opposite the cover 203 and a pair of vertically extending secondary walls (not depicted) that extend along the lateral sides of the conveyor 20 between the lower plate and the sidewalls 214 of the cover 203. In certain examples, the cover 203, the lower plate, and/or the walls encircle the belt 21 and define a passageway 205 through which the conveyor 20 extends and the food products are conveyed. In certain examples, the cover 203 is movable relative to the lower plate and/or the wall which may be fixed to the frame 15. The tunnel 201 is configured to constrain the microwave energy in the passageway 205 as the microwave energy moves in a direction away from the microwave control module 40 (see upstream direction denoted by arrow B).

One or more rods 217 (FIG. 9) extend between the sidewalls 214, and the rods 217 increase the rigidity and stability of the cover 203. The cover 203 includes one or more flanges 218 (FIG. 9) that extend to engage and/or overlap the walls (not depicted). A bracket 219 at the first end 211 is configured to translatably and/and pivotably couple the cover 203 to the frame 15 (described further herein). The bracket 219 is configured to engage with a pivot member 18 that is coupled to the frame 15. The pivot member 18 can be slidably movable on the frame 15, and the pivot member 18 laterally extends along a pivot axis 220 between the opposing lateral sides of the frame 15. In certain examples, the pivot member 18 is a cylindrical rod or square tubing that is elongated along a pivot axis 220. In certain examples, the pivot axis 220 is adjacent to the conveyor 20 and/or extends in a lateral direction across the conveyor 20.

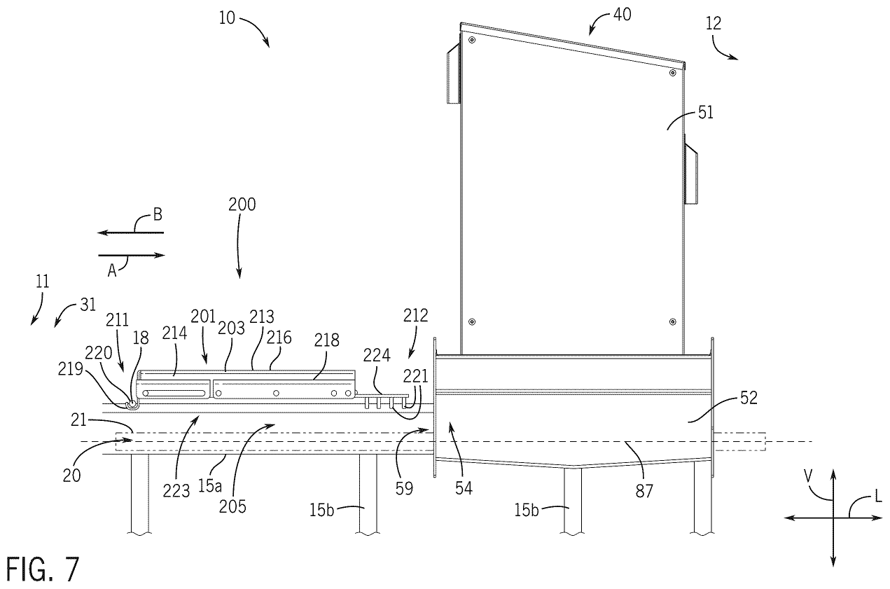

A plurality of microwave pin chokes 221 are coupled to the first surface 215 and are configured to extend toward the conveyor 20 when the cover 203 is in the first position (FIG. 6). The number, spacing, size, and/or the pattern on the pin chokes 221 on the first surface 215 can vary, and in the example depicted in FIG. 9 a plurality of pin chokes 221 are arranged in four laterally extending linear rows. Reference is made to U.S. Pat. No. 4,488,027 for further description of example known pin chokes and tunnels which features and/or components may be included with the microwave suppression system 200 of the present disclosure. In the examples depicted, the base plate 213 includes a first plate section 223 and a second plate section 224. The pin chokes 221 are positioned on the second plate section 224. Note that the sidewalls 214 of the cover 203 do not extend along the lateral sides of the second plate section 224 (see FIG. 7).

The cover 203 is movable into different positions by the operator, and FIGS. 6-9 depicts the cover 203 in various positions.

FIG. 6 depicts the cover 203 in an operating or first position in which the second plate section 224 and the pin chokes 221 (depicted in dashed lines in FIG. 5) extend into the second interior space 54 of the microwave control module 40. In certain examples, in the first position the cover 203 longitudinally extends along the conveyor 20 and/or the cover 203 extends parallel with the conveyor 20. The pin chokes 221 are oriented toward the belt 21. The pin chokes 221 are in the second interior space 54 to thereby help prevent microwaves from leaking from the microwave control module 40 and/or help define the microwave distribution field affecting the food products in the microwave control module 40. In certain examples, the pin chokes 221 extend into the second interior space 54 thereby providing a more compact tunnel 201 and tighter control on suppression of the microwave energy within the microwave control module 40.

Note that extending the second plate section 224 with the pin chokes 221 into the adjacent module, e.g., the microwave control module 40, also prevents ‘gaps’ along the top of the microwave suppression system 200 between the upper second surface 216 of the microwave suppression system 200 and the sidewall of the microwave control module 40. Furthermore, by extending the pin chokes 221 into the second interior space 54 the microwave suppression system 200 engages electrically (i.e. ground) without additional mechanical constraints or components. In certain examples, microwave suppression systems 200 adjacent to both opposing openings 59 of the microwave control module 40 isolate and/or control the microwave energy generated by the microwave control module 40 thereby providing control of processes where finite microwave energy applications are required. In certain examples, the microwave suppression system 200 includes coupling an additional plurality of pin chokes to the module which emits microwaves, such as the microwave control module 40, which are not coupled to the base plate 213 of the cover 203. In these examples, the pin chokes on the module and the pin chokes 221 on the base plate 213 collectively prevent microwave leakage. In certain examples, the pin chokes 221 are configured to act microwave chokes that prevents the propagation of microwaves thereby

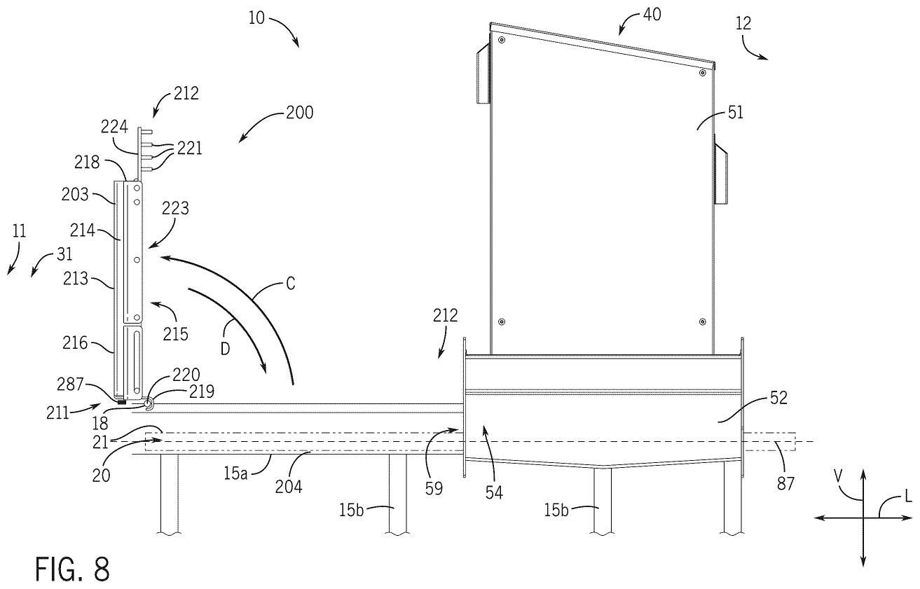

As noted above, cleaning of the system 10 is important for food safety and/or quality considerations, and accordingly, the cover 203 is configured to move from the first position (FIG. 6) into one or more cleaning or second positions (FIG. 8) in which the surfaces of the cover 203, the pin chokes 221, and/or other components are exposed and easily cleaned.

FIG. 7 depicts the cover 203 moved into an intermediate position in which the cover 203 is longitudinally spaced apart from the microwave control module 40 and the second plate section 224 with the pin chokes 221 are located outside of the microwave control module 40. In intermediate position the cover 203 clears the microwave control module 40 and/or is not obstructed by the microwave control module 40. The cover 203 is moved from the first position to the intermediate position by applying a pulling force to the cover 203 in the upstream direction (see arrow B) such that the cover 203 longitudinally translates in the longitudinal upstream direction (arrow B) along the frame 15. In certain examples, the flanges 218 (FIG. 9) slide along the lower walls and/or the pivot member 18 moves with the bracket 219. In certain examples, the pivot member 18 moves in slots (not depicted) defined by the frame 15. In the intermediate position, the pin chokes 221 are oriented toward the conveyor 20. Note that the operator may shut down the system 10 and/or turn off the waveguide assemblies 90 (FIG. 2) so that the operator can safely move the cover 203 into the intermediate position without risk of being exposed to excessive amounts of microwaves.

After the cover 203 is moved into the intermediate position (FIG. 7), the operator can pivot the cover 203 about the pivot axis 220 away from the conveyor 20 (see arrow C depicting pivoting the cover 203 in a first pivot direction away from the conveyor 20) into the cleaning or second position (FIG. 8) in which the surfaces of the cover 203, the pin chokes 221, and/or other components are exposed and easily accessible for cleaning and/or repair. The bracket 219 remains coupled to the pivot member 18. In the second position, the cover 203 transversely extends away from the frame 15 and/or the belt 21. In certain examples, in the second position the cover 203 extends perpendicular to the frame 15 and/or the belt 21. In certain examples, in the second position the cover 203 and the belt 21 define an acute (e.g., 45.0 degrees) or an obtuse (e.g., 110.0 degrees) therebetween. In certain examples, a locking device 287 (FIG. 8 e.g., spring pin, pin, latch) locks the cover 203 in the second position and prevents inadvertent movement of the cover 203 toward the belt 21.

To move the cover 203 from the second position back to the intermediate position, the operator pivots the cover 203 about the pivot axis 220 in a second pivot direction (see arrow D). The operator can then move the cover 203 in the downstream direction (arrow A) into the first position (FIG. 6) such that the second plate section 224 and the pin chokes 221 extend into the microwave control module 40.

Referring now to FIG. 10, an example control system 300 of the system 10 (FIG. 1) is depicted. The control system 300 is for controlling the operation of the system 10 and the various components, systems, and features noted above and described below. The control system 300 can include various components, modules, and/or subsystems, some of which are described herein below. In the example depicted in FIG. 10, the control system 300 includes a controller 325 that controls the system 10. In one example, the controller 325 is a programmable logic controller (PLC).

The controller 325 receives power from a power system 320, which in certain examples includes an electrical connection to the power systems of the facility or building in which the system 10 is assembled, batteries, and/or other energy storage systems known in the art. The power system 320 can also provide power to other components of the system 10.

The controller 325 includes a processor 326, which may be implemented as a microprocessor or the circuitry, or be disturbed across multiple processing devices or sub-systems that cooperate to execute an executable program 330 from a memory 329. Note that the example depicted in FIG. 10 includes one controller 325 in association with other components of the system 10. However, other configurations of the control system 300 are possible including configurations having multiple controllers or sub-controllers. Note that the controller 325 can be located anywhere on the system 10.

The memory 329 can include any storage media readable by the processor 326 and capable of storing the executable program 330 and/or data 331. The memory 329 may be implemented as a single storage device, or be distributed across multiple storage devices or sub-systems that cooperate to store computer readable instructions, data structures, program modules, or other data.

Peripheral devices, such as user interface devices 307, and output devices such as alarms 333 (e.g., audible alarms, visual light alarms), are in communication with the controller 325 (described further herein). In practice, the processor 326 loads and executes an executable program 330 from the memory 329, accesses data 331 stored within the memory 329, and directs the system 10 to operate.

The control system 300 communicates with the systems and/or components of the system 10 via communication links 322, which can be any wired or wireless links. The illustrated communication links 322 between functional and logical block components are merely exemplary, which may be direct or indirect, and may follow alternate pathways. In one example, the communication link 322 is a controller area network (CAN) bus; however, other types of links could be used.

The control system 300 communicates with the user interface device 307 that is configured to receive input data from the operator and/or a remote device via a network (not depicted). The user interface device 307 is also capable of displaying data and other information (e.g., maintenance alerts) to the operator. The user interface device 307 can be any suitable device such as a touch screen or a peripheral computer. The control system 300 also communicates and/or receives data from the various systems as described in further detail below. Furthermore, other systems of the system 10 or components related to the system 10 are in communication with the controller 325, such as the food processing module 32, the microwave control module 40, and the microwave suppression system 200, and components thereof (e.g., sensors). Note that while some of the components described herein below are depicted in FIG. 10 as part of various systems, the components can be independent of the systems or part of different systems.

In certain examples, the microwave generating device (e.g., magnetron 81) is in communication with the control system 300 such that operation of the microwave generating device and thereby the microwave energy generated can be controlled (described further herein). The microwave control module 40 can include microwave sensors 340 configured to sense microwave energy propagating through the waveguide assemblies 90 (FIG. 2). The microwave sensors 340 provide microwave data to the control system 300 that corresponds to the amount of microwave energy within food processing module 32 or the microwave control module 40. The control system 300 can process the microwave data and/or provide control signals to the microwave generating device to thereby adjust microwave energy emitted into the second interior space 54. In certain examples, a bi-directional or directional coupler 310 is in communication with the control system 300, and the coupler 310 also provides microwave data to the control system 300. In certain examples, the microwave sensor(s) 340 and the coupler 310 can be independent from modules 32, 40. Also note that any number of microwave sensors 340 may be utilized with the system 10. In another example, the operator selects a preprogrammed microwave energy power level (e.g., levels 0-10) that corresponds to a specific percent of the maximum energy output of the microwave generating device. For instance, when the operator selects “Level 5”, the control system 300 will control the microwave generating devices such that the microwave generating devices output 50.0% of the maximum energy output. Note that the microwave energy power level can be part of the recipe (noted below) for cooking the food products.

The system 10 can include one or more sensors, such as inductive or proximity sensors 344, for sensing presence of any module or section 31, 32, 40 and/or the microwave suppression system 200. Note that any module of the system 10 can include the tunnels 201. When the proximity sensors 344 sense the presence of the microwave suppression system 200 or the cover 203 in an operating position, the proximity sensors 344 send proximity signals or data to the control system 300 that corresponds to the presence of the microwave suppression system 200 and thus the presence of the corresponding tunnels 201. Accordingly, the control system 300 determines that the microwave generating devices can be operated because the microwave suppression system 200 is present and can therefore absorb microwave energy that may leak from the microwave control module 40. If however, the proximity sensors 344 do not sense the presence of the microwave suppression system 200 or a cover 203 in the intermediate position or second position, the proximity sensors 344 do not send proximity data to the control system 300 and the control system 300 determines that the microwave suppression system 200 is not properly positioned. Therefore, the control system 300 prevents the microwave generating devices from generating microwave energy to protect the operator from being exposed to potentially harmful microwave energy. Note that in certain examples, the proximity sensors 344 are substituted with limit switches 348 that are configured to determine presence of the microwave suppression system 200 and generate the proximity data noted above.

In certain examples, the user interface device 307 receives input data from the operator. The inputs received may be related to specific operations of the system 10 and/or components thereof. For example, the operator may input data corresponding to a desired temperature within the system 10. The control system 300 processes the data and controls the modules 32, 40 to thereby adjust the temperature within the system 10. The temperature sensors 336 can provide feedback signals to the control system 300 such that that control system 300 further controls the modules 32, 40. In other examples, the operator inputs data corresponding to a desired belt speed. Accordingly, the control system 300 processes the data and controls the conveyor 20 accordingly.

The operator can enter a recipe into the control system 300 via the user interface device 307. The recipe includes cooking input data for processing the food product conveyed through the system 10. Operating the system 10 according to the recipe will result in the food products being cooked to a desired specification. The recipe can include input data corresponding to cooking time, belt speed, fan or blower speed, temperature within the food processing module 32 (FIG. 1), humidity within the food processing module 32, microwave energy power level for the microwave control module 40, and the like.

The recipe can also be pre-saved onto the memory 329 such that an operator simply selects a recipe via the user interface device 307. Note that other inputs related to operation of specific components of the system 10 and/or the recipe itself can be transmitted to the controller 325 over a network (not depicted) from a remote computer, cellular phone, control panel, and/or terminal. Further note that one or more recipes can be stored on the memory 329 such that the operator can select the desired recipe. In certain examples, the recipe includes cooking data for operating multiple food processing modules 32 and/or microwave control modules 40. In certain examples, a single recipe is used for controlling each module 32, 40. In other examples, the recipe includes different cooking data for each module 32, 40.

In certain independent examples, a food processing system for processing a food product includes a module with a microwave generating device configured to generate microwave energy to process the food product, a conveyor extending through the module and configured to convey the food product through the module, and a microwave suppression system configured to prevent leakage of the microwave energy from the food processing system. The microwave suppression system includes a cover with a plurality of pin chokes coupled thereto that is movable relative to the conveyor and the module and selectively extends into the module.

Optionally the cover is movable into and between a first position in which the cover extends along the conveyor and a second position in which the cover extends transverse to the conveyor. Optionally in the first position at least a portion of the plurality of pin chokes extend into the module. Optionally in the first position the plurality of pin chokes are oriented toward the conveyor. Optionally in the second position the plurality of pin chokes are oriented away from the conveyor. Optionally the plurality of pin chokes extend perpendicular from a base plate of the cover. Optionally the food processing system further includes a pivot member that extends along a pivot axis and the cover is pivotable about the pivot axis in a first pivot direction away from the conveyor and an opposite second pivot direction toward the conveyor. Optionally the cover includes a bracket pivotably coupled to the pivot member. Optionally the food processing system further comprising a frame that vertically supports the conveyor, the microwave suppression system, and the module, and the pivot member is slidably coupled to the frame. Optionally the pivot member laterally extends across the conveyor. Optionally the cover is movable into an intermediate position between the first position and the second position. In the intermediate position the cover extends along the conveyor and is spaced apart from the module and in the first position, the cover extends into the module. Optionally the cover is translatable between the first position and the intermediate position and the cover is pivotable between the intermediate position and the second position.

In certain independent examples, a method for processing a food product in a food processing system includes processing, with a module configured to generate microwaves, the food product, conveying, with a conveyor, the food product through the module, and moving a cover with pin chokes coupled thereto of a microwave suppression system relative to the module to selectively extend into the module and prevent leakage of microwaves from the food processing system.

Optionally the moving the cover includes moving the cover from a first position in which the cover extends along the conveyor to a second position in which the cover extends transverse to the conveyor. Optionally the moving the cover from the first position to the second position includes translating the cover along the conveyor and pivoting the cover about a pivot axis. Optionally the moving the microwave suppression system includes translating the cover along the conveyor from a first position in which the pin chokes extend into the module to an intermediate position in which the cover clears the module and pivoting the cover about a pivot axis away from the conveyor from the intermediate position toward a second position in which cover extends transverse to the conveyor. Optionally wherein the moving the microwave suppression system includes pivoting the cover about a pivot axis toward the conveyor from a second position in which the cover extends transverse to the conveyor to an intermediate position in which the cover and the pin chokes are adjacent to the module and translating the cover along the conveyor from the intermediate position to a first position in which the cover and the pin chokes extend into the module. Optionally in the first position, the plurality of pin chokes are oriented toward the conveyor. Optionally in the second position, the plurality of pin chokes are oriented away from the conveyor. Optionally in the second position, the plurality of pin chokes are oriented away from the conveyor.

In certain independent examples, a food processing system for processing a food product includes a module with a microwave generating device configured to generate microwave energy to thereby cook the food product, a conveyor configured to convey the food product through the module to thereby cook the food product as the food product is conveyed through the module, the conveyor longitudinally extending an axis and a tunnel configured to absorb microwave energy leaking from the module to thereby reduce leakage of microwave energy from the food processing system. The tunnel having a cover configured to selectively translate in along the axis and further pivot away from the conveyor such that the underside cover can be cleaned by an operator.

In certain independent examples, a food processing system for processing a food product includes a conveyor configured to longitudinally convey the food product from an upstream first machine end toward a downstream second machine end of the system and a microwave control module through which the conveyor extends and having one or more waveguide assemblies configured to generate microwave energy to process the food products as the conveyor conveys the food products through the processing microwave processing module. A food processing module through which the conveyor extends and positioned downstream of the microwave control module, the food processing module having one or more waveguide assemblies configured to generate microwave energy and process the food product as the conveyor conveys the food products through the processing microwave processing module. A microwave suppression system adjacent to the microwave control module for isolating the and constraining the microwaves in the microwave control module such that the food product is subjected to concentrated microwave energy while in the microwave control module.

Optionally, the microwave control module has an interior space in which single wavelength microwave energy are emitted, and the food products are processed by the microwave energy while being conveyed through the interior space. The food processing module has a chamber in which microwave energy is emitted such that microwave energy in the chamber has a multi-mode field pattern, and the food products are processed by the microwave energy while being conveyed through the chamber.

In certain independent examples, a method for processing a food product includes conveying, with a conveyor, the food product from an upstream first end toward a downstream second end of the system, processing the food product in a microwave control module to thereby preprocess the food product, the conveyor extend through the microwave control module, and the microwave control module has one or more waveguide assemblies configured to direct microwave energy to process the food products as the conveyor conveys the food products through the processing microwave processing module. The method can include the step of processing the food product in a food processing module that is downstream from the microwave control module to thereby further process the food product, the conveyor extend through the food processing module, and the food processing module has one or more waveguide assemblies configured to direct microwave energy to process the food products as the conveyor conveys the food products through the food processing module.

Citations to a number of references are made herein. The cited references are incorporated by reference herein in their entireties. In the event that there is an inconsistency between a definition of a term in the specification as compared to a definition of the term in a cited reference, the term should be interpreted based on the definition in the specification.

In the present description, certain terms have been used for brevity, clarity, and understanding. No unnecessary limitations are to be inferred therefrom beyond the requirement of the prior art because such terms are used for descriptive purposes and are intended to be broadly construed. The different apparatuses, systems, and method steps described herein may be used alone or in combination with other apparatuses, systems, and methods. It is to be expected that various equivalents, alternatives, and modifications are possible within the scope of the appended claims.

The functional block diagrams, operational sequences, and flow diagrams provided in the Figures are representative of exemplary architectures, environments, and methodologies for performing novel aspects of the disclosure. While, for purposes of simplicity of explanation, the methodologies included herein may be in the form of a functional diagram, operational sequence, or flow diagram, and may be described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology can alternatively be represented as a series of interrelated states or events, such as in a state diagram. Moreover, not all acts illustrated in a methodology may be required for a novel implementation.

This written description uses examples to disclose the invention and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A food processing system for processing a food product, the food processing system comprising:
a module with a microwave generating device configured to generate microwave energy to process the food product;
a conveyor extending through the module and configured to convey the food product through the module; and
a microwave suppression system configured to prevent leakage of the microwave energy from the food processing system, the microwave suppression system includes a cover with a plurality of pin chokes coupled thereto that is movable relative to the conveyor and the module and selectively extends into the module.

2. The food processing system according to claim 1, wherein the cover is movable into and between:
a first position in which the cover extends along the conveyor; and
a second position in which the cover extends transverse to the conveyor.

3. The food processing system according to claim 2, wherein in the first position, at least a portion of the plurality of pin chokes extend into the module.

4. The food processing system according to claim 2, wherein in the first position, the plurality of pin chokes are oriented toward the conveyor.

5. The food processing system according to claim 4, wherein in the second position, the plurality of pin chokes are oriented away from the conveyor.

6. The food processing system according to claim 4, wherein the plurality of pin chokes extend perpendicular from a base plate of the cover.

7. The food processing system according to claim 2, wherein the food processing system further includes a pivot member that extends along a pivot axis; and
wherein the cover is pivotable about the pivot axis in a first pivot direction away from the conveyor and an opposite second pivot direction toward the conveyor.

8. The food processing system according to claim 7, wherein the cover includes a bracket pivotably coupled to the pivot member.

9. The food processing system according to claim 7, the food processing system further comprising a frame that vertically supports the conveyor, the microwave suppression system, and the module; and
wherein the pivot member is slidably coupled to the frame.

10. The food processing system according to claim 9, wherein the pivot member laterally extends across the conveyor.

11. The food processing system according to claim 2, wherein the cover is movable into an intermediate position between the first position and the second position;
wherein in the intermediate position, the cover extends along the conveyor and clears the module; and
wherein in the first position, the cover extends into the module.

12. The food processing system according to claim 11, wherein the cover is translatable between the first position and the intermediate position; and
wherein the cover is pivotable between the intermediate position and the second position.

13. A method for processing a food product in a food processing system, the method comprising:
processing, with a module configured to generate microwaves, the food product;
conveying, with a conveyor, the food product through the module; and
moving a cover with pin chokes coupled thereto of a microwave suppression system relative to the module to selectively extends into the module and prevent leakage of microwaves from the food processing system.

14. The method according to claim 13, wherein the moving the cover includes moving the cover from a first position in which the cover extends along the conveyor to a second position in which the cover extends transverse to the conveyor.

15. The method according to claim 14, wherein the moving the cover from the first position to the second position includes translating the cover along the conveyor and pivoting the cover about a pivot axis.

16. The method according to claim 13, wherein the moving the microwave suppression system includes:
translating the cover along the conveyor from a first position in which the pin chokes extend into the module to an intermediate position in which the cover clears the module; and
pivoting the cover about a pivot axis away from the conveyor from the intermediate position toward a second position in which cover extends transverse to the conveyor.

17. The method according to claim 13, wherein moving the microwave suppression system includes:
pivoting the cover about a pivot axis toward the conveyor from a second position in which the cover extends transverse to the conveyor to an intermediate position in which the cover and the pin chokes are adjacent to the module; and
translating the cover along the conveyor from the intermediate position to a first position in which the cover and the pin chokes extend into the module.

18. The method according to claim 17, wherein the first position, the plurality of pin chokes are oriented toward the conveyor.

19. The method according to claim 18, wherein in the second position, the plurality of pin chokes are oriented away from the conveyor.

20. The method according to claim 17, wherein in the second position, the plurality of pin chokes are oriented away from the conveyor.
